(19) United States
(12) Patent Application Publication
(10) Pub. No.: US 2019/0191864 A1
(43) Pub. Date: Jun. 27, 2019

(54) HAIR BRUSH WITH HEXAGONAL BRISTLES

(71) Applicant: Shordee Products LLC, Cedarhurst, NY (US)

(72) Inventors: Dena Pilevsky, Woodsburgh, NY (US); David Farrage, Demarest, NJ (US)

(73) Assignee: Shordee Products LLC, Cedarhurst, NY (US)

(21) Appl. No.: 16/288,267

(22) Filed: Feb. 28, 2019

Related U.S. Application Data
(63) Continuation-in-part of application No. 29/611,664, filed on Jul. 24, 2017, now Pat. No. D844331.
Application No. 29/611,664 is a continuation-in-part of application No. 15/822,390, filed on Nov. 27, 2017.
(60) Provisional application No. 62/402,305, filed on Sep. 30, 2016.
(60) Provisional application No. 62/757,992, filed on Nov. 9, 2018.

(51) Int. Cl. A46B 17/06; A46B 9/02; A46B 15/00; A46B 5/00; A46B 9/06; B08B 1/00

(52) U.S. Cl. CPC A46B 17/06; A46B 9/023; A46B 15/0059; B08B 1/001; A46B 5/00; A46B 9/028; A46B 9/06; A46B 15/0061

(57) ABSTRACT

A hair brush having a handle attached to a head that accommodates a bristle pad with apertures for holding rows of bristle elements. A first type of bristle element or hexagonal bristle has a wide base that culminates in a tapered tip, and a cross-section having a hexagonal configuration. A second type of bristle element or boar hair bristle has a cluster of boar hairs bunched together at a single position or aperture on the bristle pad. The handle of the brush incorporates a tubular lined cavity covered by an end cap. The cavity may be utilized for storage or to accommodate a cleaning apparatus to remove or dislodge accumulated dirt, oil, built-up hair products and strands of hair from the bristle elements and bristle pad of the brush.

### CROSS-REFERENCE TO RELATED APPLICATIONS

This U.S. nonprovisional patent application is a continuation in part of U.S. design application 29/611664, filed on Jul. 24, 2017, and now allowed; and a continuation in part of U.S. non-provisional application Ser. No. 15/822,390, filed on Nov. 27, 2017, and now pending, which claims priority to provisional patent application 62/402,305, filed on Sep. 30, 2016. This U.S. nonprovisional patent application also claims priority to U.S. provisional patent application 62/757,992, filed on Nov. 9, 2018. Each of these applications are incorporated by reference herein in their entireties.

### TECHNICAL FIELD

The present invention relates to a brush, and more particularly, to a hair and styling brush having bristles with a hexagonal configuration

### BACKGROUND OF THE INVENTION

Several unique hair brushes have been created and disclosed in the prior art for use in styling and brushing hair. For example, U.S. Design Pat. D832591 discloses a hair brush having triangular bristles with an opening at the base of each bristle. Each of the bristles are tapered from the wider base to the tip of each bristle. U.S. Pat. D815837 discloses a hair comb that incorporates two different bristle designs, wherein a single outer row of round bristles surrounds an interior group of bristles that have an flat, oval cross-section. US Published Application 2018/0228277 discloses a hairbrush with an array of bristles. Some of the bristles have a wide base and narrow top at the free end of the bristle, wherein the bristles are sized and arranged so that the first portion of each bristle serves to penetrate and divide hair between the bristles and the second portion enables tension to be applied to the hair when hair flows between the bristles. Other prior art hair brushes include EU Registered Community Design 003067065-0003, which discloses a brush with bristles having a smooth conical configuration, and EU Registered Community Design 003067065-0005, which discloses bristles having complex curved features and with openings in the body of several bristles.

In addition to the foregoing hair brushes, other modern hair brushes that are widely available to consumers exclusively utilize natural boar hair bristles. Boar hair bristles are touted as offering several benefits in hair care. For examples, boar hair bristles assist with spreading of oils produced by the scalp to ends of each strand of hair. By coating each strand of hair with the natural oils of the scalp, boar hair bristles help condition and repair dry hair and improve its texture. In view of the natural benefits of utilizing boar hair bristles, the need for hair conditioners and serums are reduced. Boar hair bristles are also touted to be able to reduce frizz and effectively stimulate a user's scalp.

In some hair brushes, clusters or tufts of boar hair bristles are combined with thin, plastic standalone bristles or spines, that are set in a series of rows along a bristle pad, and are sometimes coated and finished with a rounded plastic tip. The tufts of boar hair (or in some cases synthetic hairs, such as nylon) are positioned at or adjacent to the plastic bristle spines. Typically, each plastic bristle extends somewhat higher than an adjacent clusters of boar hairs (or synthetic hairs). Hair brushes that combine clusters of boar hair bristles with plastic spines offer users the benefits of boar hair brushes as well as the benefits of longer standalone plastic bristles that help stimulate and massage the scalp.

Notwithstanding the intended utility and benefits of these and other conventional hair brushes that are disclosed in the prior art, most do not offer a bristle configuration that brushes hair in a manner that effectively detangles tresses with minimal discomfort. For example, while many hair brushes claim to be able to detangle hair while brushing without painfully tearing hairs out from the scalp, few accomplish this task successfully.

Moreover, with each progressive use, hair brushes typically accumulate dirt, oil, built-up hair products and strands of hair. And, over time, the strands and other products may form unwanted clumps of hair. To maintain hygiene, it is beneficial to remove these unwanted items from a hair brush on a regular basis. However, cleaning hair brushes often present difficulties to users and is generally a time-consuming process.

### SUMMARY OF THE INVENTION

In view of the drawbacks of the prior art, it is a primary objective of the present invention to provide a hair brush with hexagonal bristles which effectively brushes and detangles strands of hair during use of the hair brush.

It is another objective of the present invention to provide a hair brush with hexagonal bristles that incorporates a cavity in the handle of the hair brush to accommodate a cleaning apparatus to eliminate accumulated dirt, oil, built-up hair products and strands of hair from the hair brush.

It is a further objective of the present invention to provide a hair brush with hexagonal bristles that rests upright on its end to preserve space on a surface upon which the hair brush is resting.

According to an exemplary embodiment of the present invention, there is disclosed a brush formed with a handle attached to a head that accommodates a bristle pad with apertures for holding rows of bristle elements. A first type of bristle element or hexagonal bristle has a wide base that culminates in a rounded, tapered tip, and a cross-section having a hexagonal configuration. A second type of bristle element or boar hair bristle has a cluster of boar hairs bunched together at a single position or aperture on the pad. The handle of the brush incorporates a tubular lined cavity covered by an end cap to which there is attached a cleaning apparatus with cleaning teeth that are adapted to remove or dislodge accumulated dirt, oil, built-up hair products and strands of hair from the bristle elements and pad of the brush.

Additional features of the hair brush with hexagonal bristles are described below in more detail.

### BRIEF DESCRIPTION OF THE DRAWINGS

The above and other features and aspects of the present invention will become more apparent by describing in detail exemplary embodiments thereof with reference to the accompanying drawings, in which:

FIG. 1 is a top, front and right-side perspective view illustrating a hair brush with hexagonal bristles according to an exemplary embodiment of the present invention;

FIG. 2 is a right-side view illustrating a hair brush with hexagonal bristles according to an exemplary embodiment of the present invention;

FIG. 3 is a top plan view a hair brush with hexagonal bristles according to an exemplary embodiment of the present invention;

FIG. 4 is a top, front and right-side perspective view of a first exemplary embodiment of a hexagonal bristle according to the present invention;

FIG. 5 is a top, front and right-side perspective view of a second exemplary embodiment of a hexagonal bristle according to the present invention;

FIG. 6 is a top, front and right-side perspective view of a third exemplary embodiment of a hexagonal bristle according to the present invention;

FIG. 7 is a top, front and right-side perspective view of a cleaning comb attached to a base and end cap; and

FIG. 8 is a cross-sectional view taken along line 8-8 of FIG. 2, illustrating the cleaning comb within the handle of the brush when the cleaning comb is stowed within the handle for storage, according to an exemplary embodiment of the present invention.

### DETAILED DESCRIPTION OF THE EMBODIMENTS

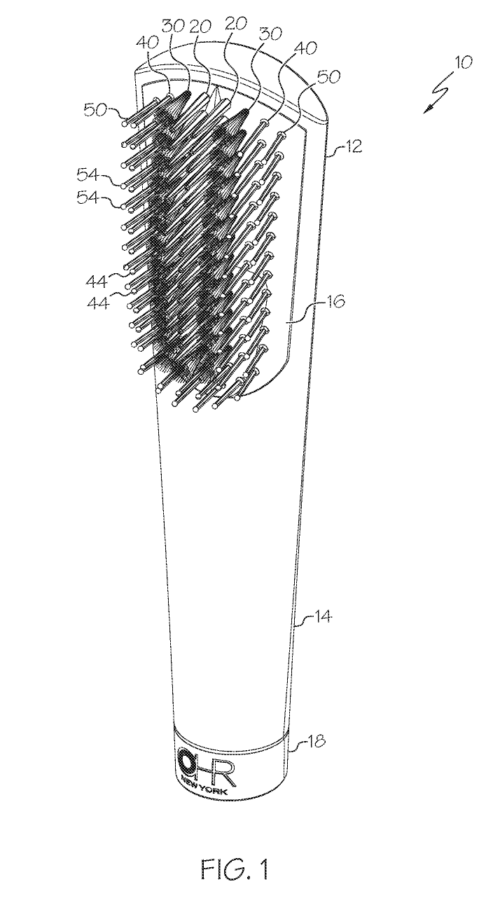

Exemplary embodiments of the present invention will be described more fully hereinafter with reference to the accompanying drawings, FIGS. 1 through 8.

The present invention may, however, be embodied in different forms and should not be construed as limited to the embodiments set forth herein. Like reference numerals may refer to like elements throughout the specification. The sizes or proportions of elements illustrated in the drawings may be exaggerated for clarity. When an element is described as being on another element, the element may be directly disposed on the other element or intervening elements may be disposed therebetween.

The present invention relates to a brush 10 comprising an upper portion or head 12 that is attached to and transitions seamlessly into a lower portion or handle 14. Head 12 and handle 14 of brush 10 may be constructed from conventional materials known in the art, including wood, plastic(s), resin(s) and metal(s), or a combination thereof. In addition, the exterior of brush 10 may be coated by conventional coatings and other materials known in the art. In a preferred embodiment, head 12 and handle 14 of brush 10 are formed of a solid section of wood.

Head 12 has a brush pad or bristle pad 16 that is attached to and rests within a space or hollow portion of head 12. In a preferred embodiment, the edges of bristle pad 16 rest securely within grooves or channels that are carved and form a concealed perimeter around brush pad 16. Head 12 is sized and adapted to accommodate bristle pad 16, preferably constructed of rubber or other elastomeric material. Brush 10 tapers from head 12 down to handle 14 to permit a more comfortable grip. Brush 10 defines a tapered contour when proceeding from head 12 down to the handle 14. Preferably, handle 14 culminates at the lower end of brush 10 in an end cap 18 having a flat surface or features which enable brush 10 to stand upright while resting on a table or other resting surface. By being able to stand upright, brush 10 utilizes less space and causes less clutter. When secured and twisted to a closed position at the end of handle 14, end cap 18 thus serves as a base stand upon which brush 10 stands upright when not in use. Notably, however, even without end cap 18, handle 14 is constructed so that brush 10 may stand upright. Preferably, end cap 18 is formed of conventional plastic(s). However, it should be appreciated and understood that end cap 18 may also be formed using metal, rubber and/or wood or other conventional materials known in the art.

Although not illustrated in the drawings, bristle pad 16 is embossed or molded with a micro-hexagonal or honeycomb pattern. Approximately 30-35 hexagons are molded across the widest section of bristle pad 16 and approximately 20-25 hexagons are molded across the narrowest section of bristle pad 16. Generally, with of each hexagon in the pattern across the flats is approximately 1.6 millimeters.

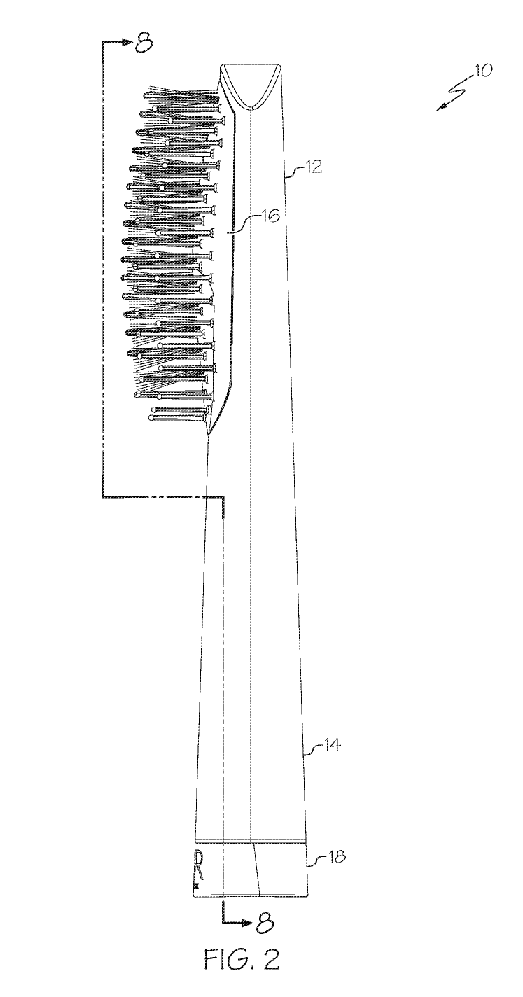

As illustrated most clearly in FIG. 1, FIG. 2 and FIGS. 4 through 6, bristle pad 16 includes a series of bristle pad apertures to accommodate a variety of bristle elements 20, 30, 40, 50 having different dimensions and features. In exemplary embodiments, bristle pad 16 comprises 90-120 bristle apertures to accommodate a like number of bristles elements. In a preferred embodiment, there are approximately eight rows of bristle elements 20, 30, 40, 50 (counting down from the upper edge of head 12), with a total of approximately twenty-nine of bristle element 20; twenty-seven of bristle element 30; twenty-nine of bristle element 40; and thirty of bristle element 50. Notwithstanding the precise number of each of the bristle elements set forth herein, it should be appreciated an understood that one bristle element may be exchanged with or replaced by another bristle element. Likewise, additional bristle elements may be added to bristle pad 17 as desired to accommodate the space provided on bristle pad 16.

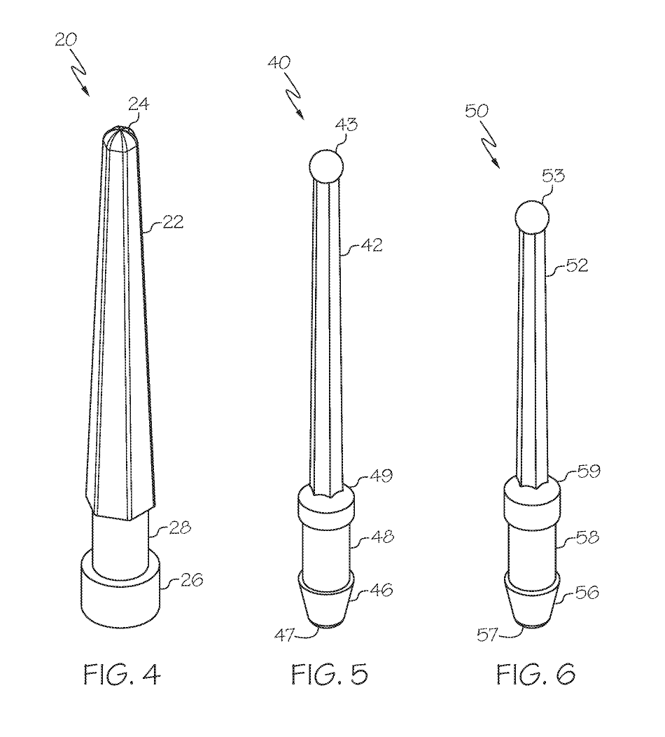

Referring to FIG. 1 and FIG. 4, bristle element 20 has an elongated hexagonal shaft or body 22 with a cross-section that gradually tapers as each bristle element 20 extends upward and away from bristle pad 16. Although shaft 22 of bristle element 20 tapers as it extends upwards, it should be appreciated and understood that the shaft 22 may have a generally uniform cross-section that does not taper. The shape of the hexagonal body 22 allows bristle element 20 to efficiently glide through hair during use of brush 10. Bristle element 20 may have a solid or hollow cross-section. Bristle element 20 also comprise a rounded tip 24 comprising the same material as shaft 22. However, it is understood that the tip of each bristle element 20 may have other shapes such as a flattened shape, pyramid shape, curved shape, concave end or pointed tip. Bristle element 20 may alternatively be constructed with a spherical or ball tip, or with an epoxy coated tip or other flexible soft plastic tip. In addition, it should be appreciated and understood that the shaft of bristle element 20 is not limited to a hexagonal cross-section. For example, bristles may have a partially flat and/or partially curved cross-section, or may have a round or a different polygonal cross-section (e.g, triangle, diamond, square, pentagon)

As illustrated in FIG. 4, bristle element 20 further comprises a plug or anchor base 26 and cylindrical shaft 28 that are inserted into bristle pad apertures to secure bristle element 20 in place within bristle pad 16. The height of cylindrical shaft 28 comprises a dimension that corresponds to the thickness of bristle pad 16 in the location where each bristle element 20 is inserted. This helps prevent undesired movement and accumulation of dirt, oil and hair product in the area of each bristle element 20.

In a preferred embodiment, hexagonal shaft 22 of bristle element 20 measures approximately 19.5 millimeters in height, not including the height of anchor base 26 or cylindrical shaft 28. Rounded tip 24 of bristle element 20 measures approximately 1.5 millimeters in diameter. The diameter of the hexagonal shaft 22 at the bottom edge thereof (where hexagonal shaft 22 meets cylindrical shaft 28) measures approximately 3.0 millimeters in diameter (or 2.6 millimeters across opposite flat sides of the hexagon).

Referring to FIG. 1 through FIG. 3, bristle element 30 preferably comprises a cluster or group of upwardly extending boar hair bristles. Unlike the hexagonal shaft 22 of bristle element 20 that tapers from the widened base as it extends upward, bristle element 30 flares out from the base where the boar hairs meet. Thus, the base of bristle element 30 form a diameter of approximately 2.5 millimeters where the boar hairs of bristle element 30 meet bristle pad 16 and flare out to approximately 5.0 millimeters at the top. In a preferred embodiment, bristle element 30 also extends 19.0 millimeters from bristle pad 16, after bristle element 30 is secured to the bristle pad. Although boar hairs are preferred, it should be appreciated and understood that other natural and/or synthetic bristle hairs may be utilized instead of or in addition to the boar hair bristles. Moreover, it should also be appreciated and understood that even though the preferred embodiment utilizes two rows of boar hair bristles 30, fewer or more rows may be utilized as well.

Referring to FIG. 1 and FIG. 5, bristle element 40 has an elongated hexagonal shaft or body 42 with a cross-section that gradually tapers as each bristle element 40 extends upward and away from bristle pad 16. Although shaft 42 of bristle element 40 tapers as it extends upwards, it should be appreciated and understood that the shaft 42 may have a generally uniform cross-section that does not taper. The shape of the hexagonal body 42 allows bristle element 40 to efficiently glide through hair during use of brush 10. Bristle element 40 may have a solid or hollow cross-section. Bristle element 40 also comprises a molded ball tip 43 comprising the same material as shaft 42, with an epoxy dipped tip 44 creating a soft flexible coating. However, it is understood that the tip of each bristle element 40 may have other shapes such as a flattened shape, pyramid shape, curved shape, concave end or pointed tip. In addition, it should be appreciated and understood that the shaft of bristle element 40 is not limited to a hexagonal cross-section. For example, bristles may have a partially flat and/or partially curved cross-section, or may have a round or different polygonal cross-section.

As illustrated in FIG. 5, bristle element 40 further comprises a plug or anchor base 46 and cylindrical shaft 48 that are inserted into bristle pad apertures to secure bristle element 40 in place within bristle pad 16. Unlike anchor base 36, anchor base 46 incorporates an inverted insertion head 47 that is smaller at the bottom and widens as it meets cylindrical shaft 48. The height of cylindrical shaft 48 comprises a dimension that corresponds to the thickness of bristle pad 16 in the location where each bristle element 40 is inserted. This helps prevent undesired movement and accumulation of dirt, oil and hair product in the area of each bristle element 40.

In a preferred embodiment, hexagonal shaft 42 of bristle element 40 measures approximately 19.0 millimeters in height (with the height of the epoxy dipped ball tip 44), not including the height of anchor base 46 or cylindrical shaft 48. Epoxy dipped tip 44 of bristle element 40 measures approximately 1.6 millimeters in diameter. Without the epoxy dip, the ball tip 43 of bristle element 40 measures approximately 1.3 millimeters in diameter. Where shaft 42 commences adjacent to the ball tip 43, the diameter of the hexagonal shaft 42 measures approximately 0.8 millimeters (or 1.0 millimeters across opposite flat sides of the hexagon). The bottom edge 49 of the hexagonal shaft 42 measures approximately 1.8 millimeters in diameter (or 1.5 millimeters across opposite flat sides of the hexagon).

Referring to FIG. 1 and FIG. 6, bristle element 50 has an elongated hexagonal shaft or body 52 with a cross-section that gradually tapers as each bristle element 50 extends upward and away from bristle pad 16. Although shaft 52 of bristle element 50 tapers as it extends upwards, it should be appreciated and understood that the shaft 52 may have a generally uniform cross-section that does not taper. The shape of the hexagonal body 52 allows bristle element 50 to efficiently glide through hair during use of brush 10. Bristle element 50 may have a solid or hollow cross-section. Bristle element 50 also comprises a molded ball tip 53 comprising the same material as shaft 52, with an epoxy dipped tip 54 creating a soft flexible coating. However, it is understood that the tip of each bristle element 50 may have other shapes such as a flattened shape, pyramid shape, curved shape, concave end or pointed tip. In addition, it should be appreciated and understood that the shaft of bristle element 50 is not limited to a hexagonal cross-section. For example, bristles may have a partially flat and/or partially curved cross-section, or may have a round or different polygonal cross-section.

As illustrated in FIG. 6, bristle element 50 further comprises a plug or anchor base 56 and cylindrical shaft 58 that are inserted into bristle pad apertures to secure bristle element 50 in place within bristle pad 16. Unlike anchor base 36, anchor base 56 incorporates an inverted insertion head 57 that is smaller at the bottom and widens as it meets cylindrical shaft 58. The height of cylindrical shaft 58 comprises a dimension that corresponds to the thickness of bristle pad 16 in the location where each bristle element 50 is inserted. This helps prevent undesired movement and accumulation of dirt, oil and hair product in the area of each bristle element 50.

In a preferred embodiment, hexagonal shaft 52 of bristle element 40 measures approximately 15.0 millimeters in height (with the height of the epoxy dipped ball tip 54), not including the height of anchor base 56 or cylindrical shaft 58. Epoxy dipped tip 54 of bristle element 50 measures approximately 1.6 millimeters in diameter. Without the epoxy dip, the ball tip 53 of bristle element 50 measures approximately 1.3 millimeters in diameter. Where shaft 52 commences adjacent to the ball tip 53, the diameter of the hexagonal shaft 52 measures approximately 0.8 millimeters (or 1.0 millimeters across opposite flat sides of the hexagon). The bottom edge 59 of the hexagonal shaft 52 measures approximately 1.25 millimeters in diameter (or 1.0 millimeters across opposite flat sides of the hexagon). Overall, except for the differences in measurements specified herein, bristle element 50 is similar in structure and appearance to bristle element 40, as contrasted with bristle element 20 which is thicker and more rigid and which does not incorporated a dipped epoxy or other soft plastic tip.

As shown most clearly in FIG. 2, bristle elements 20, 30, 40, 50 generally form an uneven and curved surface or canopy when they are anchored to brush pad 16, even though some are of the same or similar height. However, it should be appreciated an understood that bristle elements 20, 30, 40, 50 may be formed and positioned on brush pad 16 in a manner which results in an even canopy forming a single and predominantly flat surface where the tips of the bristle elements culminate in the same height.

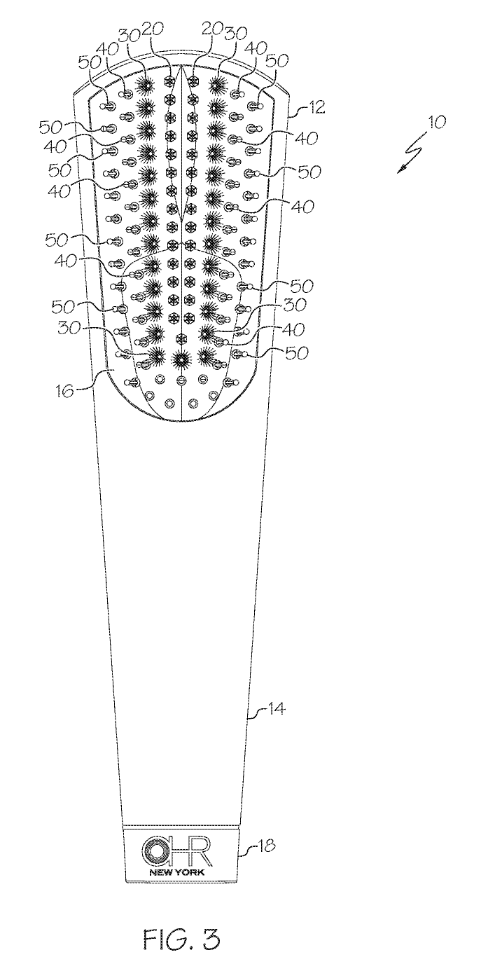

With reference to FIG. 3, a preferred embodiment of brush 10 comprises two center rows of bristle element 20, flanked on either side by a row of boar hairs or bristle element 30. Thereafter, and proceeding outward from the center of brush 10, there is a row of bristle element 40 followed by a row of bristle element 50. Regardless of the particular bristle elements that are utilized, it is desirable in many instances to incorporate bristles that have soft, plastic ball tips on the outer two rows, with the more rigid bristles located centrally on the brush pad 16.

Generally, bristle elements 20, 40, 50 are formed separately from bristle pad 16 by using molds having the desired shapes and sizes. When manufacturing pad 16 separately from the bristle elements 20, 40, 50, a first mold may be used to form the pad 16 with the holes or apertures out of conventional plastic(s) or rubber materials. For bristle elements 20, 40, 50, different molds are utilized and they are filled with flowable plastic(s) to form bristle elements 20, 40, 50 or any other conventional materials known in the art. Preferably, nylon material is utilized in connection with the formation of each bristle element 20, 40, 50. Ideally, the shaft of each bristle element is 20, 40, 50 is flexible yet resilient in order to retain an upward posture after repeated use of the brush. Alternatively, bristle elements 20, 40, 50 may be formed via extrusion, particularly, with regard to thinner bristle elements 40, 50. Although somewhat flexible, interior hexagonal bristles 20 are predominantly rigid as compared to the thinner exterior hexagonal bristles 40, 50. After being created, bristle elements 20, 40, 50, each having hexagonal shafts 22, 42, 52, are inserted into and fastened to bristle pad 16 in the desired locations, respectively, in accordance with the recommendations set forth herein or in other configurations, yet still keeping within the spirit and scope of the invention. Bristle elements 20, 40, 50 may also be formed in a manner so that they are interchangeable with each other and may be positioned as desired in the bristle pad apertures of the bristle pad 16. For those bristles that have a soft tip, such as bristle elements 40, 50, may be dipped or over molded with a soft plastic, epoxy or resin. Once the bristle pad 16 and bristle elements 20, 30, 40, 50 are formed and assembled, they may be inserted into and fastened to head 12 of brush 10.

Notwithstanding the preferred embodiment and mode of production, an alternate bristle pad may be manufactured together as one integral and continuous structure (e.g., as one piece) with non-hair based bristles to reduce manufacturing costs. In that regard a bristle pad and non-hair based bristles may be formed utilizing plastic, metal and/or wood or other conventional materials known in the art. In addition, the selected pad and/or the non-hair based bristles may be elastic, partially rigid or rigid.

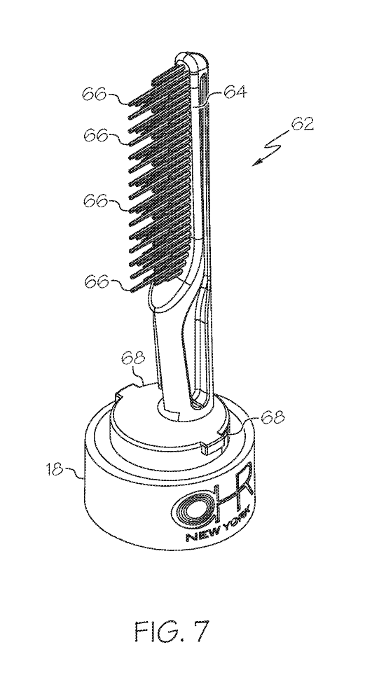

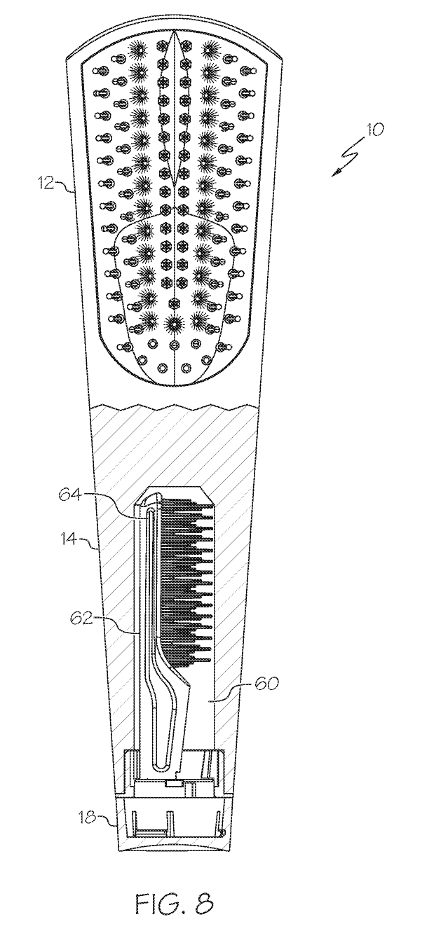

As illustrated in FIG. 7 and FIG. 8, handle 14 defines an internal cavity 60 constructed as a tubed lining within which a cleaning apparatus 62 is housed. Cavity 60 may also be utilized for storage of other items, as desired. If cavity 60 is utilized for storage purposes, cleaning apparatus 62 should be removed entirely or made smaller to allow sufficient space. If cleaning apparatus 62 is removed, end cap 18 may still be utilized to seal tubular lined cavity 60 via a twist lock mechanism that locks end cap 18 to handle 14, and magnets 68. Cleaning apparatus 62 appears as a miniature comb having a spine 64 with quills or teeth 66 having various lengths to help eliminate accumulated dirt, oil, built-up hair products and strands of hair from brush 10. End cap 18 and cleaning apparatus 62 are secured to handle 14 via magnets 68 and/or mechanical locking means to ensure that the end cap 18 does not fall away from handle 14 during use of brush 10. As shown in FIG. 7, cleaning apparatus 62 rests on a pedestal formed by end cap 18 so that it stands upright when resting on a surface. As an alternative to the cleaning apparatus 62 illustrated in FIG. 7, a comb, mirror or shorter brush may be provided and housed in cavity 60.

The accompanying specification and drawings only illustrate an exemplary embodiment of a brush with hexagonal bristles, its constituent parts, and associated methods and processes. However, other exemplary embodiments are possible, and the drawings are not intended to be limiting in that regard. Thus, although the description above and accompanying drawings contains much specificity, the details provided should not be construed as limiting the scope of the embodiment(s) but merely as providing illustrations of some of the presently preferred embodiment(s). The drawings and the description are not to be taken as restrictive on the scope of the embodiment(s) and are understood as broad and general teachings in accordance with the present invention. While the present embodiment(s) of the invention have been described using specific terms, such description is for present illustrative purposes only, and it is to be understood that modifications and variations to such embodiments, including but not limited to the substitutions of equivalent features, materials, or parts, and the reversal of various features thereof, may be practiced by those of ordinary skill in the art without departing from the spirit and scope of the invention.

1. A brush, comprising:
a head;
a handle attached to said head, said handle comprising a cavity within said handle;
a cap covering said cavity;
a bristle pad with a plurality of apertures, said bristle pad positioned at said head;
a first plurality of bristle elements positioned in said plurality of pad apertures, each of said first plurality of bristle elements comprising a hexagonal cross-section;
a second plurality of bristle elements positioned in said plurality of pad apertures, each of said second plurality of bristle elements comprising a cluster of hair; and
a selectively removable cleaning apparatus adapted to be housed with said cavity of said handle.

2. The brush of claim 1, wherein each of said first plurality of bristle elements further comprise an anchor base to secure each of said first plurality of bristle elements to said bristle pad.

3. The brush of claim 1, further comprising a third plurality of bristle elements, each of said third plurality of bristle elements comprising a hexagonal cross-section and a flexibly soft ball tip.

4. The brush of claim 4, wherein said second plurality of bristle elements are positioned between said first plurality of bristle elements and said third plurality of bristle elements on said bristle pad.

5. The brush of claim 4, wherein each of said first plurality of bristle elements have a hexagonal base and each of said third plurality of bristle elements have a hexagonal base, and further wherein said hexagonal base of each of said first plurality of bristle elements is wider than said hexagonal base of each of said third plurality of bristle elements.

6. The brush of claim 1, wherein said cluster of hair comprises boar hairs.

7. The brush of claim 1, wherein said cluster of hair comprises synthetic hairs.

8. The brush of claim 1, wherein said cleaning apparatus comprises a cleaning comb with teeth.

9. The brush of claim 8, wherein said cleaning apparatus is attached to said cap covering said cavity.

10. The brush of claim 9, wherein said cap is fastened to said handle via a magnet.

11. A brush, comprising:
a head;
a handle attached to said head;
a bristle pad with a plurality of apertures, said bristle pad positioned at said head; and
a first plurality of bristle elements positioned in said plurality of pad apertures, each of said first plurality of bristle elements comprising a hexagonal cross-section, a cylindrical shaft and anchor base, said cylindrical shaft and said anchor base adapted to secure each of said first plurality of bristle elements to said brush pad.

12. The brush of claim 11, further comprising a second plurality of bristle elements positioned in said plurality of pad apertures, each of said second plurality of bristle elements comprising a cluster of boar hair.

13. The brush of claim 12, wherein each of said first plurality of bristle elements have a base and a tip, wherein said base is wider than said tip.

14. The brush of claim 13, further comprising a third plurality of bristle elements wherein each of said third plurality of bristle elements comprise a hexagonal cross-section and a soft ball tip.

15. The brush of claim 14, each of said first plurality of bristle elements and each of said third plurality of bristle elements further comprising a shaft, said shaft of said first plurality of bristle elements being thicker than said shaft of each of said third plurality of bristle elements.

16. A brush, comprising:
a head;
a bristle pad with a plurality of apertures, said bristle pad positioned at said head; and
a first plurality of bristle elements positioned in said plurality of pad apertures, each of said first plurality of bristle elements comprising a hexagonal cross-section and an anchor base, said anchor base adapted to secure each of said first plurality of bristle elements to said bristle pad;
a second plurality of bristle elements comprising clusters of boar hair bristles, said clusters of boar hair bristles positioned in said plurality of pad apertures; and
a third plurality of bristle elements positioned in said plurality of pad apertures, each of said third plurality of bristle elements comprising a hexagonal cross-section, a soft top and an anchor base, said anchor base adapted to secure each of said third plurality of bristle elements to said bristle pad;
wherein said first plurality of bristle elements is taller than said third plurality of bristle elements.

17. The brush of claim 16, further comprising a handle.

18. The brush of claim 17, further comprising a cavity in said handle, and a cap covering said cavity.

19. The brush of claim 18, further comprising a selectively removable cleaning tool in said cavity of said handle.

20. The brush of claim 16, said first plurality of bristle elements comprising a rounded and rigid tip.
